(19) United States
(12) Patent Application Publication
(10) Pub. No.: US 2011/0218809 A1
(43) Pub. Date: Sep. 8, 2011

(54) VOICE SYNTHESIS DEVICE, NAVIGATION DEVICE HAVING THE SAME, AND METHOD FOR SYNTHESIZING VOICE MESSAGE

(75) Inventors: Ryuichi Suzuki, Okazaki-city (JP); Takashi Ooi, Chiryu-city (JP)

(73) Assignee: DENSO CORPORATION, Kariya-city (JP)

(21) Appl. No.: 13/023,000

(22) Filed: Feb. 8, 2011

(30) Foreign Application Priority Data
Mar. 2, 2010 (JP) 2010-45238

(51) Int. Cl. G10L 13/08

(52) U.S. Cl. 704/260; 704/E13.008

(57) ABSTRACT

A voice synthesis device includes: a memory for storing a plurality of recorded voice data; a dividing unit for dividing a text into a plurality of words or phrases, wherein the text is to be converted into a voice message; a verifying unit for verifying whether one of the recorded voice data corresponding to each word or phrase is disposed in the memory; and a voice synthesizing unit for preparing a whole of the text with the recorded voice data when all of the recorded voice data corresponding to all of the plurality of words or phrases are disposed in the memory, and for preparing the whole of the text with rule-based synthesized voice data when at least one of the recorded voice data corresponding to one of the plurality of words or phrases is not disposed in the memory.

### CROSS REFERENCE TO RELATED APPLICATION

This application is based on Japanese Patent Application No. 2010-45238 filed on Mar. 2, 2010, the disclosure of which is incorporated herein by reference.

### FIELD OF THE INVENTION

The present invention relates to a voice synthesis device for synthesizing a voice message, a method for synthesizing a voice message, and a navigation device having a voice synthesis device.

### BACKGROUND OF THE INVENTION

An in-vehicle navigation device has a function for outputting a voice message when the device talks back in order to confirm a voice input by an user, when the device guides a route, or when the device informs the user of traffic information. In this case, the voice message to be output from the device is prepared by a recorded voice, a synthesized voice, and/or a combination of the recorded voice and the synthesized voice. The synthesized voice is prepared by a voice synthesizing method such as a speech-synthesis-by-rule method (rule-based speech synthesis method). Recently, a method for approaching a sound quality of the synthesized voice to a sound quality of a recorded voice is developed. However, the sound quality of the synthesized voice is lower than the sound quality of the recorded voice. Thus, it is preferable to use the recorded voice having good sound quality. However, since the data amount of the recorded voice is large, the number of words and phrases is limited, and therefore, only typical words and phrases are registered in a standard recorded voice database.

In view of the above difficulties, JP-A-H09-97094 and JP-A-2007-257231 teach that a voice message to be output from the device is divided into multiple paragraphs. When one of the paragraphs coincides with a content registered in the standard recorded voice database, the content of the standard recorded voice database is used as a recorded voice for the one of the paragraphs. When another one of the paragraphs does not coincide with a content registered in the standard recorded voice database, the another one of the paragraphs is synthesized by the speech synthesis by rule method or the like, and the synthesized voice is used for the another one of the paragraphs. Thus, the recorded voice and the synthesized voice are mixed, and then, the mixed voice message is output.

In the above case, since the mixed voice message of the recorded voice and the synthesized voice is output, a voice quality of the mixed voice message is largely changed at a boundary between the recorded voice and the synthesized voice. Thus, a comprehension level is reduced. To improve the comprehension level, JP-A-2008-225254 corresponding to US 2008/0228487 and JP-A-2009-037214 corresponding to US 2009/0018837 teach that a device for improving the comprehension level when the recorded voice and the synthesized voice are combined in order to form a voice message. The device disclosed in JP-A-2008-225254 calculates connection distortion between the recorded voice and the synthesized voice, and considers the voice type of a word just before the connection so that a voice change between the recorded voice and the synthesized voice is reduced. The device disclosed in JP-A-2009-037214 improves naturalness of a hearing sense between the recorded voice and the synthesized voice.

However, in the devices disclosed in JP-A-2008-225254 and JP-A-2009-037214, when the recorded voice and the synthesized voice are mixed, the comprehension level may be improved. However, the voice quality at the boundary between the recorded voice and the synthesized voice is changed, so that the comprehension level is not completely improved.

### SUMMARY OF THE INVENTION

In view of the above-described problem, it is an object of the present disclosure to provide a voice synthesis device for synthesizing a voice message, a method for synthesizing a voice message, and a navigation device having a voice synthesis device. In the voice synthesis device and the method for synthesizing a voice message, a comprehension level is improved even when a recorded voice and a synthesized voice are mixed, and a mixed voice message is output.

According to a first aspect of the present disclosure, a voice synthesis device includes: a memory for storing a plurality of recorded voice data; a dividing unit for dividing a text into a plurality of words or phrases, wherein the text is to be converted into a voice message; a verifying unit for verifying whether one of the recorded voice data corresponding to each word or phrase is disposed in the memory; and a voice synthesizing unit for preparing a whole of the text with the recorded voice data when all of the recorded voice data corresponding to all of the plurality of words or phrases are disposed in the memory, and for preparing the whole of the text with rule-based synthesized voice data when at least one of the recorded voice data corresponding to one of the plurality of words or phrases is not disposed in the memory.

In the device, since the recorded voice and the rule-based synthesized voice are not mixed, the comprehension level of the voice message is not reduced.

According to a second aspect of the present disclosure, an in-vehicle navigation device includes the voice synthesis device according to the first aspect of the present disclosure. The navigation device provides the voice message with the comprehension level, which is improved. According to a third aspect of the present disclosure, a method for synthesizing voice includes: storing a plurality of recorded voice data in a memory; dividing a text into a plurality of words or phrases, wherein the text is to be converted into a voice message; verifying whether one of the recorded voice data corresponding to each word or phrase is disposed in the memory; preparing a whole of the text with the recorded voice data when all of the recorded voice data corresponding to all of the plurality of words or phrases are disposed in the memory; and preparing the whole of the text with rule-based synthesized voice data when at least one of the recorded voice data corresponding to one of the plurality of words or phrases is not disposed in the memory.

In the method, since the recorded voice and the rule-based synthesized voice are not mixed, the comprehension level of the voice message is not reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation device;

FIG. 2 is a block diagram showing a voice synthesis unit;

FIG. 3 is a flowchart showing a voice synthesis process;

FIG. 4 is a diagram showing a recorded voice data;

FIG. 5 is a diagram showing an example of the voice synthesis process; and

FIG. 6 is a diagram showing another example of the voice synthesis process.

### DETAILED DESCRIPTION OF THE PREFERRED EMBODIMENTS

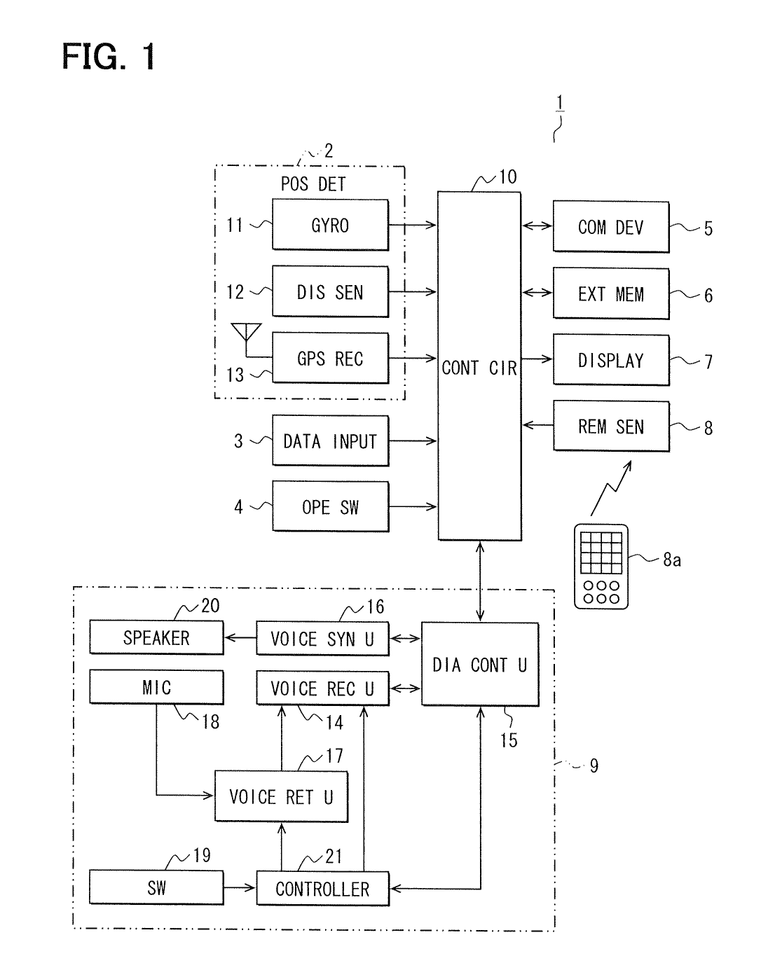

An in-vehicle navigation device according to an example embodiment will be explained with reference to FIGS. 1-6. FIG. 1 shows the navigation device 1. The device 1 includes a position detector 2, a data input element 3, multiple operation switches 4, a communication element 5, an external memory 6, a display element 7, a remote control sensor 8, a voice recognition element 9 and a control circuit 10 coupled with these elements 2-9. The control circuit 10 is a conventional computer. The control circuit 10 includes a CPU, a ROM, a RAM, a I/O element and a bus line for coupling with these elements.

The position detector 2 includes a gyroscope 11, a distance sensor 12 and a GPS receiver 13 for receiving an electric wave from a satellite so that the position detector 2 detects a current position of the vehicle based on the electric wave. Since the gyroscope 11, the distance sensor 12 and the GPS receiver 13 have different type of errors, these sensors compensates with each other so that an appropriate current position is calculated. Alternatively, only one or two of the gyroscope 11, the distance sensor 12 and the GPS receiver 13 may be used for detecting the current position when an accuracy of the current position is not high. Alternatively, a rotation sensor of a steering wheel and/or a wheel sensor of each wheel may be used for detecting the current position.

The data input element 3 inputs map matching data for improving an accuracy of position detection, navigation data including map data and a landmark data and dictionary data used for voice recognition process in the voice recognition element 9. A recording medium may be a hard disk drive or a DVD in view of a data amount. Alternatively, the recording medium may be a CD-ROM or the like. When the recording medium is the DVD, the data input element is a DVD player.

The display element 7 is a color display device. A current position mark of the vehicle input from the position detector 2, map data input from the data input element 3, and additional data such as a guiding route mark and a setting point mark displayed on the map image are overlapped and displayed on a screen of the display element 7. Further, the display element 7 displays a menu image showing multiple choices. Further, when the user selects one of the choices on the menu image, the display element 7 displays a command input image showing multiple choices.

The communication element 5 is a mobile communication device such as a cell phone in order to communicate with a certain contact device specified by contact point communication information.

The navigation device 1 has a route guiding function such that an optimum route from the current position to the destination is automatically searched, and displays and guides the optimum route as a guiding route when the user inputs a position of a destination via a remote control terminal 8a and the remote control sensor 8, or when the user inputs the position of the destination via the operation switches 4. A method for setting the optimum route automatically is, for example, a Dijkstra method. The operation switches 4 include a touch switch or a mechanical switch integrated in the display element 7. The user input various commend via the operation switches 4.

Although the operation switches 4 and the remote control terminal 8a are used for inputting various command from the user with manual operation, the voice recognition element 9 is used for inputting various command from the user with voice input operation. The voice recognition element 9 includes a voice recognition element 14, a dialog control element 15, a voice synthesis element 16, a voice retrieve element 17, a microphone 18, a switch 19, a speaker 20 and a controller 21.

The voice recognition element 14 executes a voice recognition process for recognizing an input voice data according to an instruction from the dialog control element 15, the input voice data being input from the voice retrieve element 17. The voice recognition element 14 returns the recognition results to the dialog control element 15. Specifically, the voice recognition element 14 verifies the voice data obtained from the voice retrieve element 17 with using the stored dictionary data. The voice recognition element 14 compares the voice data with multiple comparison patterns, and then, determines one of the patterns, which has the highest degree of coincidence. The voice recognition element 14 outputs the one of the patterns, which has the highest degree of coincidence, to the dialog control element 15.

When the series of words in the input voice data is recognized, first, the voice data input from the voice retrieve element 17 is acoustically analyzed with using several acoustic models so that a characteristic amount such as Cepstrum is retrieved. Thus, in the acoustic analysis step, time-series data of the characteristic amount is obtained. The time-series data of the characteristic amount is divided into multiple sections by a conventional HMM method (Hidden Markov Model method), a DP matching method or a neural network method. The voice recognition element 14 determines which word stored in the dictionary data corresponds to each section.

Based on an instruction from the controller 21 and recognition results of the voice recognition element 14, the dialog control element 15 outputs an instruction to the voice synthesis element 16 for outputting a response voice message, and transmits information to the control circuit 10 about the destination and a command in order to for example, execute a navigation process so that the control circuit 10 executes the command and sets the destination. Here, the control circuit 10 mainly executes navigation functions. As a result of these process, with utilizing the voice recognition element 9, the user can inputs the destination and the like into the navigation device 1 through a voice input method without operating the operation switches 4 and the remote control terminal 8a.

The voice synthesis element 16 synthesizes the voice corresponding to the output instruction of the response voice message from the dialog control element 15 according to the voice waveform stored in the waveform database such as a recorded voice waveform and a speech synthesized waveform by the rule method. The control functions of the voice synthesis element 16 will be explained later. Thus, the synthesized voice message is output from the speaker 20.

The voice retrieve element 17 converts the voice, around the device 1 input from the microphone 18, into the digital data, and then, outputs the digital data to the voice recognition element 14. Specifically, in order to analyze the characteristic amount of the input voice, a frame signal having a predetermined time interval such as 10 milliseconds is retrieved from the input voice. Then, the voice retrieve element 17 determines whether the input voice signal includes a section corresponding to the frame signal includes a voice or only includes a noise. Since the signal input from the microphone 18 includes not only a voice signal as an object of voice recognition but also a noise signal, the voice section and the noise section are specified. The determination whether the section of the frame signal is the voice section or the noise section is, for example, a following method such that a power of the input signal in a predetermined short time is retrieved at predetermined time intervals, the short time power equal to or larger than a predetermined threshold continues for a predetermined period or more. Thus, the voice retrieve element 17 determines whether the section of the frame signal is the voice section or the noise section. When the voice retrieve element 17 determines that the section of the frame signal is the voice section, the input signal corresponding to the voice section is output to the voice recognition element 14.

In the present embodiment, the user inputs a voice while the user is pushing on the switch 19. Specifically, the controller 21 monitors the timing when the user turns on the switch 19, the timing when the user turns off the switch 19 and a time period while the switch 19 continues to be turned on. When the user turns on the switch 19, the controller 21 outputs an instruction for executing a voice recognition process to the voice retrieve element 17 and the voice recognition element 14. However, when the user does not turn on the switch 19, the controller 21 controls the voice retrieve element 17 and the voice recognition element 14 not to execute the voice recognition process. Accordingly, while the user turns on the switch 19, the voice is input into the voice recognition element 14 via the microphone 18.

In the present embodiment, the navigation device 1 executes various processes such as a route setting process, a route guiding process, a facility searching process and a facility displaying process when the user inputs a command into the device 1.

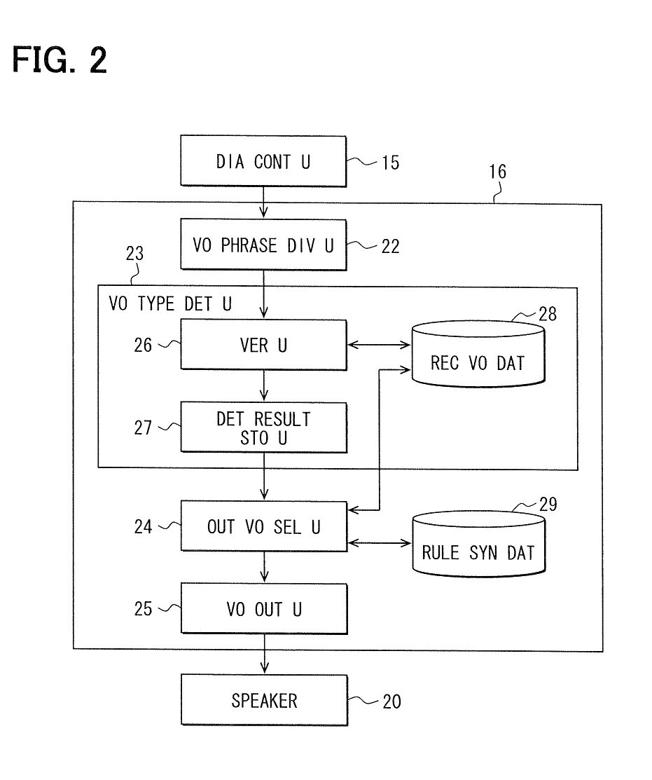

The functions and structure of the voice synthesis element 16 will be explained with reference to FIG. 2. The voice synthesis element 16 includes a voice phrase diving unit 22 as a dividing element, a voice type determining unit 23, an output voice message selecting unit 24 as a voice message synthesizing element, and a voice message outputting unit 25. The voice type determining unit 23 includes a verification unit 26 as a verifying element, a determination result storing unit 27 and a recorded voice data memory 28 as a memory for storing a recorded voice database.

The voice phrase diving unit 22 in the voice synthesis element 16 divides the text data into words or paragraphs when a text data of the voice phrase to be output from the speaker 20 is input from the dialog control element 15. The verification unit 26 in the voice type determining unit 23 determines whether each divided word or paragraph coincides with a recorded voice data stored in the recorded voice data memory 28. The determination results of the verification unit 26 are input into the determination result storing unit 27. The determination result storing unit 27 stores the determination results.

The output voice message selecting unit 24 selects based on the determination results in the determination result storing unit 27 which of the recorded voice data stored in the recorded voice data memory 28 or the rule-based synthesized data stored in the rule-based synthesis data memory 29 is used. The voice message outputting unit 25 outputs the voice message selected by the output voice message selecting unit 24 from the speaker 20.

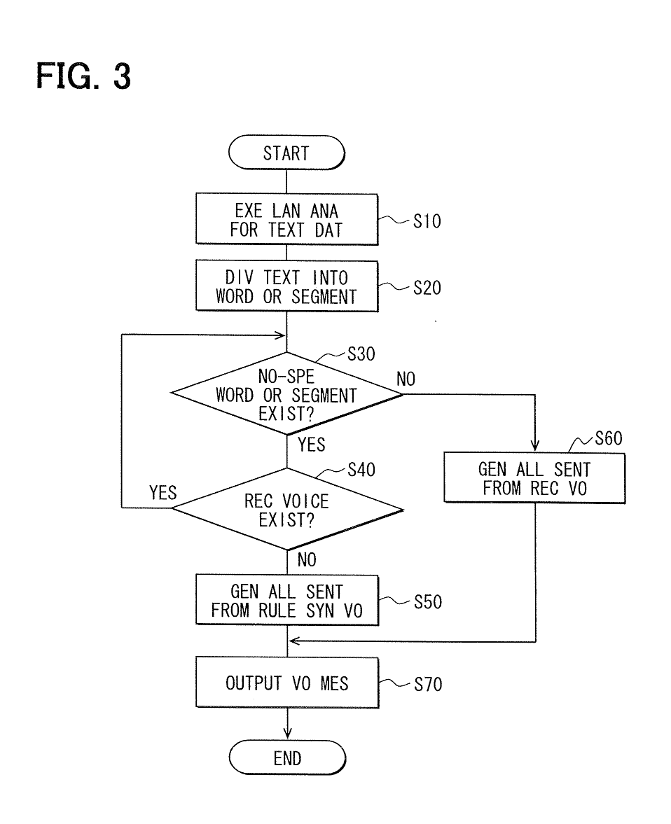

Next, the voice synthesis process in the voice synthesis element 16 will be explained with reference to FIG. 3. In step S10, the input text data of the voice phrase is linguistically analyzed (i.e., performed in a language analysis process). Next, in step S20, the text data is divided into multiple words or paragraphs.

After that, in step S30, the voice type determining unit 23 determines whether not-specified words or paragraphs exist. When the not-specified words or paragraphs exist, i.e., when the determination of step 530 is “YES,” it goes to step 540. In step 540, the voice synthesis element 16 determines whether the recorded voice corresponding to the not-specified words or paragraphs is disposed in the recorded voice data memory 28.

When the recorded voice corresponding to the not-specified words or paragraphs is disposed in the recorded voice data memory 28, it returns to step S30. Then, step S30 is repeated. When the recorded voice corresponding to the not-specified words or paragraphs is not disposed in the recorded voice data memory 28, it goes to step S50. In step S50, the output voice is selected to be the rule-based synthesis voice so that a whole of the sentence of the text data is generated by the rule-based synthesis voice. Thus, the rule-based synthesis voice corresponding to the whole of the sentence is synthesized.

In step S30, when the recorded voice corresponding to the not-specified words or paragraphs is not disposed in the recorded voice data memory 28, i.e., when the determination of step S30 is “NO,” the recorded voice corresponding to all words or paragraphs is disposed in the recorded voice data memory 28. In this case, it goes to step S60. In step S60, the output voice is selected to be the recorded voice so that a whole of the sentence of the text data is generated by the recorded voice.

Then, in step S70, the voice message generated by the recorded voice in step S60 or the rule-based synthesis voice in step S50 is output from the speaker 20. Thus, the voice synthesis process ends.

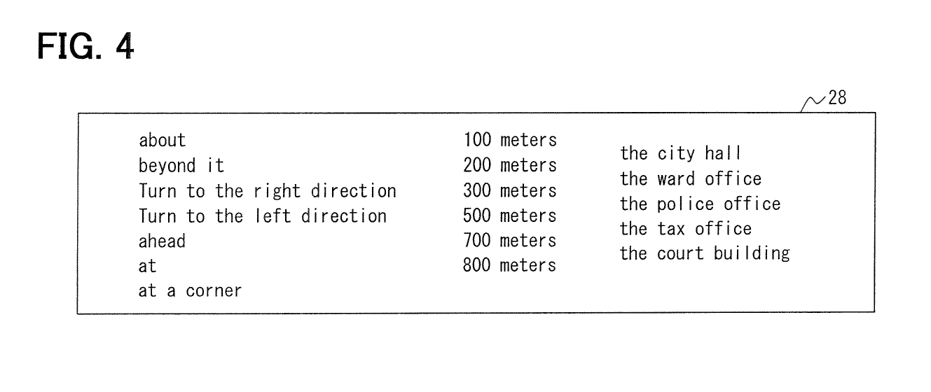

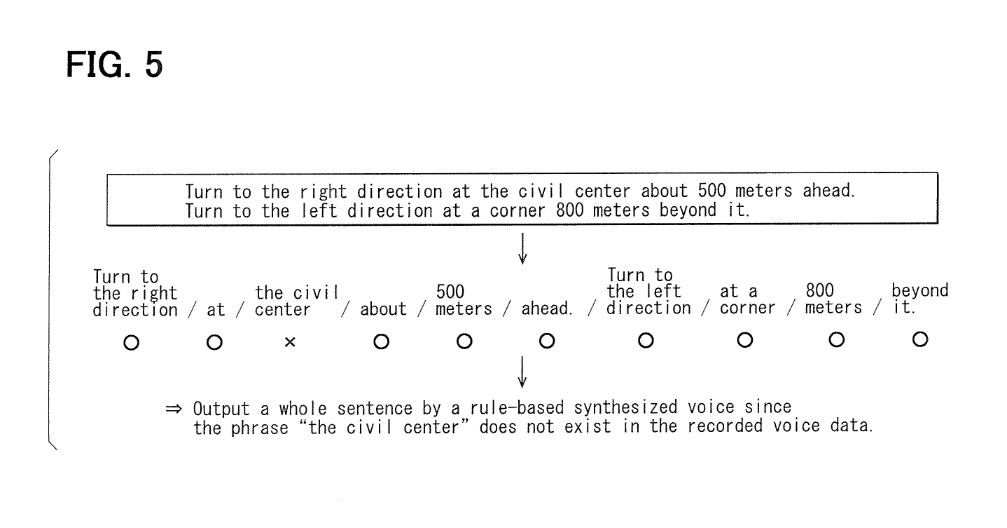

Next, an example of the voice synthesis process will be explained with reference to FIGS. 4-6. The recorded voice data shown in FIG. 4 is stored in the recorded voice data memory 28. A first example is a text of “Turn to the right direction at the civil center about 500 meters ahead. Turn to the left direction at a corner 800 meters beyond it” shown in FIG. 5, which is to be synthesized.

The above text is divided into words or paragraphs as described a divided text of “Turn to the right direction/at/the civil center/about/500 meters/ahead./Turn to the left direction/at a corner/800 meters/beyond it.” Here, the phrase “the civil center” in the divided words and paragraphs does not exist in the recorded voice data memory 28. Thus, a whole sentence, i.e., a whole text is synthesized by a rule-based synthesized voice, and then, the synthesized voice message is output.

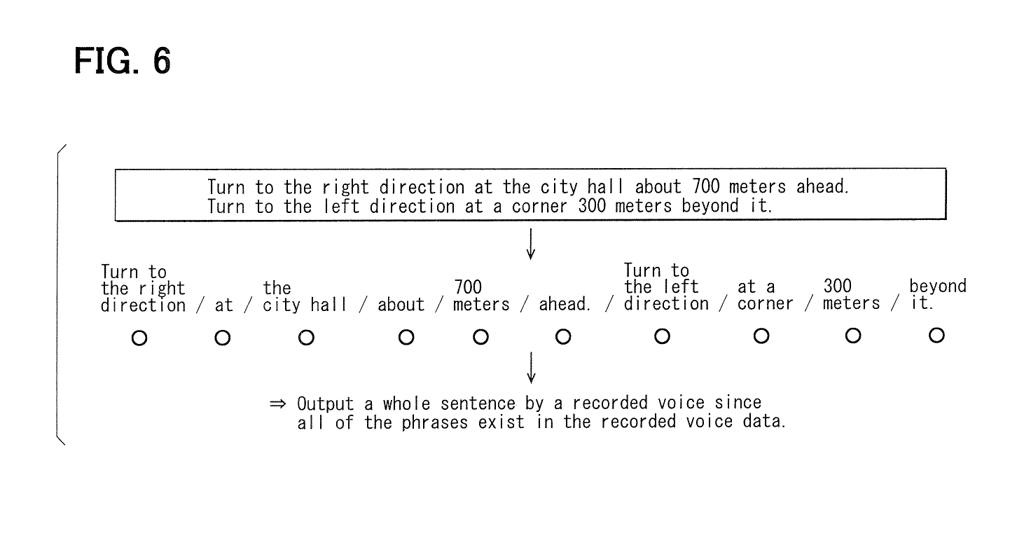

Next, a second example is a text of “Turn to the right direction at the city hall about 700 meters ahead. Turn to the left direction at a corner 300 meters beyond it” shown in FIG. 6, which is to be synthesized. The above text is divided into words or paragraphs as described a divided text of “Turn to the right direction/at/the city hall/about/700 meters/ahead./Turn to the left direction/at a corner/300 meters/beyond it.” Here, all of the phrases exist in the recorded voice data memory 28. Thus, a whole sentence, i.e., a whole text is synthesized by a recorded voice, and then, the synthesized voice message is output.

In the present embodiment, since the whole of the text to be output as the voice message is provided by only one of the recorded voice and the rule-based synthesized voice, one text does not include both of the recorded voice and the rule-based synthesized voice. Thus, there is no boundary between the recorded voice and the rule-based synthesized voice in one text. Thus, the voice quality is not largely changed in one text. Thus, the comprehension level is not reduced.

In the present embodiment, when at least one of the divided words and paragraphs does not exist in the recorded voice data memory 28, the whole of the text is prepared by the rule-based synthesized voice. Alternatively, when one of the divided words and paragraphs does not exist in the recorded voice data memory 28, the one of the divided words and paragraphs is generated, and a combination of pronunciation corresponding to letters in the one of the divided words and paragraphs may retrieved from the recorded voice data. In this case, it is necessary to store the recorded voice data corresponding to all phonic units in the recorded voice data memory 28. For example, the phonic units of the words “the civil center” are generated such as “th,” “e,” “c,” “i,” “vi,” “I,” “c,” “e,” “n,” “t;” and “er.” Each phonic unit corresponds to the recorded voice data. Thus, the whole of the text is synthesized by the recorded voice.

Alternatively, when only one of the divided words and paragraphs does not exist in the recorded voice data memory 28, the one of the divided words and paragraphs may be further divided into multiple words. Each word may correspond to the recorded voice data. For example, the paragraph “the civil center” is divided into the word “the,” the word “civil,” and the word “center.” Then, the recorded voice corresponding to the words “the,” “civil” and “center” are integrated. In this case, it is necessary to store the recorded voice data corresponding to the words “the,” “civil” and “center” in the recorded voice data memory 28. Thus, the whole of the text is synthesized by the recorded voice.

Alternatively, when only one of the divided words and paragraphs does not exist in the recorded voice data memory 28, the one of the divided words and paragraphs is synthesized by the rule-based synthesized voice, and further, other words or paragraphs are prepared by the recorded voice. Furthermore, a mute time having a predetermined time interval in a range between, for example, 0.5 second and 1.0 second is inserted at a boundary between the recorded voice and the rule-based synthesized voice. Specifically, the mute time is added before and after the rule-based synthesized voice. In this case, even when one text (i.e., one sentence) includes two different voice quality voices so that the voice quality is changed largely at the boundary between two voices, the comprehension level is improved since the mute time is disposed at the boundary of two voices having different voice qualities.

In the above case, only when the punctuation mark such as a period, a comma, and a question mark is disposed just before or just after the word or the phrase synthesized by the rule-based synthesized voice, the above voice synthesis control may be executed such that the recorded voice and the rule-based synthesized voice are mixed, and the mute time is inserted at the boundary between the recorded voice and the rule-based synthesized voice.

In the above embodiment, when only one of the divided words and paragraphs does not exist in the recorded voice data memory 28, the voice synthesis process is executed. Alternatively, when multiple divided words and paragraphs do not exist in the recorded voice data memory 28, the above voice synthesis process may be performed.

In the above embodiment, the voice synthesis device is integrated into the in-vehicle navigation device. Alternatively, the voice synthesis device may be integrated into other devices.

The above disclosure has the following aspects.

According to a first aspect of the present disclosure, a voice synthesis device includes: a memory for storing a plurality of recorded voice data; a dividing unit for dividing a text into a plurality of words or phrases, wherein the text is to be converted into a voice message; a verifying unit for verifying whether one of the recorded voice data corresponding to each word or phrase is disposed in the memory; and a voice synthesizing unit for preparing a whole of the text with the recorded voice data when all of the recorded voice data corresponding to all of the plurality of words or phrases are disposed in the memory, and for preparing the whole of the text with rule-based synthesized voice data when at least one of the recorded voice data corresponding to one of the plurality of words or phrases is not disposed in the memory.

In the device, since the recorded voice and the rule-based synthesized voice are not mixed, the comprehension level of the voice message is not reduced.

Alternatively, the memory may further store the recorded voice data corresponding to a plurality of phonic units. The voice synthesizing unit generates a sound of one of the plurality of words or phrases in such a manner that the recorded voice data corresponding to each phonic unit in the one of the plurality of words or phrases is utilized when only one of the recorded voice data corresponding to the one of the plurality of words or phrases is not disposed in the memory. In this case, since the recorded voice and the rule-based synthesized voice are not mixed, the comprehension level of the voice message is not reduced.

Alternatively, the voice synthesizing unit may prepare one of the plurality of words or phrases with the rule-based synthesized voice data, prepares other words or phrases with the recorded voice data, and inserts a mute time just before and just after the one of the plurality of words or phrases when only one of the recorded voice data corresponding to the one of the plurality of words or phrases is not disposed in the memory. The mute time provides to improve the comprehension level of the voice message.

Alternatively, the voice synthesis device may further include: a dialog control unit for generating the text; and a speaker for outputting the voice message prepared by the recorded voice data or the rule-based synthesized voice data.

According to a second aspect of the present disclosure, an in-vehicle navigation device includes the voice synthesis device according to the first aspect of the present disclosure. The navigation device provides the voice message with the comprehension level, which is improved.

According to a third aspect of the present disclosure, a method for synthesizing voice includes: storing a plurality of recorded voice data in a memory; dividing a text into a plurality of words or phrases, wherein the text is to be converted into a voice message; verifying whether one of the recorded voice data corresponding to each word or phrase is disposed in the memory; preparing a whole of the text with the recorded voice data when all of the recorded voice data corresponding to all of the plurality of words or phrases are disposed in the memory; and preparing the whole of the text with rule-based synthesized voice data when at least one of the recorded voice data corresponding to one of the plurality of words or phrases is not disposed in the memory.

In the method, since the recorded voice and the rule-based synthesized voice are not mixed, the comprehension level of the voice message is not reduced.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred,, other combinations and configurations, including more, less or only a single element, are also within the spirit and scope of the invention.

What is claimed is:

1. A voice synthesis device comprising:
a memory for storing a plurality of recorded voice data;
a dividing unit for dividing a text into a plurality of words or phrases, wherein the text is to be converted into a voice message;
a verifying unit for verifying whether one of the recorded voice data corresponding to each word or phrase is disposed in the memory; and
a voice synthesizing unit for preparing a whole of the text with the recorded voice data when all of the recorded voice data corresponding to all of the plurality of words or phrases are disposed in the memory, and for preparing the whole of the text with rule-based synthesized voice data when at least one of the recorded voice data corresponding to one of the plurality of words or phrases is not disposed in the memory.

2. The voice synthesis device according to claim 1,
wherein the memory further stores the recorded voice data corresponding to a plurality of phonic units, and
wherein the voice synthesizing unit generates a sound of one of the plurality of words or phrases in such a manner that the recorded voice data corresponding to each phonic unit in the one of the plurality of words or phrases is utilized when only one of the recorded voice data corresponding to the one of the plurality of words or phrases is not disposed in the memory.

3. The voice synthesis device according to claim 1,
wherein the voice synthesizing unit prepares one of the plurality of words or phrases with the rule-based synthesized voice data, prepares other words or phrases with the recorded voice data, and inserts a mute time just before and just after the one of the plurality of words or phrases when only one of the recorded voice data corresponding to the one of the plurality of words or phrases is not disposed in the memory.

4. The voice synthesis device according to claim 1, further comprising:
a dialog control unit for generating the text; and
a speaker for outputting the voice message prepared by the recorded voice data or the rule-based synthesized voice data.

5. An in-vehicle navigation device comprising the voice synthesis device according to claim 1.

6. A method for synthesizing voice comprising:
storing a plurality of recorded voice data in a memory;
dividing a text into a plurality of words or phrases, wherein the text is to be converted into a voice message;
verifying whether one of the recorded voice data corresponding to each word or phrase is disposed in the memory;
preparing a whole of the text with the recorded voice data when all of the recorded voice data corresponding to all of the plurality of words or phrases are disposed in the memory; and
preparing the whole of the text with rule-based synthesized voice data when at least one of the recorded voice data corresponding to one of the plurality of words or phrases is not disposed in the memory.
